(19) United States
(12) Patent Application Publication
(10) Pub. No.: US 2017/0373500 A1
(43) Pub. Date: Dec. 28, 2017

(54) Method for Adaptive Demand Charge Reduction

(71) Applicant: Robert Bosch GmbH, Stuttgart (DE)

(72) Inventors: Sayed Yusef Shafi, San Francisco, CA (US); Maksim V. Subbotin, San Carlos, CA (US); Ashish S. Krupadanam, Cupertino, CA (US); Binayak Roy, Mountain View, CA (US); Jasim Ahmed, Mountain View, CA (US)

(21) Appl. No.: 15/538,699

(22) PCT Filed: Dec. 22, 2015
(86) PCT No.: PCT/US2015/067491

§ 371 Date: Jun. 22, 2017

Related U.S. Application Data
(60) Provisional application No. 62/095,810, filed on Dec. 23, 2014.
(60) Provisional application No. 62/095,455, filed on Dec. 22, 2014.

(51) Int. Cl. H02J 3/28; G05B 13/02

(52) U.S. Cl. CPC H02J 3/28; G05B 13/027

(57) ABSTRACT

A method for peak load shaving uses an energy storage device. A controller predicts the threshold above which the energy consumed by a load is equal to the capacity of the storage device. Load forecasting methods include artificial neural networks and support vector machines to compute a real-time threshold estimate that is used to decide when to dispatch power from the energy storage device. The threshold estimates are adapted iteratively, using the most recent observed load and previous threshold estimates. The adaptive algorithm reduces the peak demand charge assessed to the customer compared to existing static approaches that compute dispatch policies in advance.

### CLAIM OF PRIORITY

This application claims priority to U.S. Provisional Application No. 62/095,455, which is entitled “Method for Adaptive Demand Charge Reduction,” and was filed on Dec. 22, 2014, the entire contents of which are hereby incorporated by reference herein. This application claims further priority to U.S. Provisional Application No. 62/095,810, which is entitled “Method for Adaptive Demand Charge Reduction,” and was filed on Dec. 23, 2014, the entire contents of which are hereby incorporated by reference herein.

### FIELD

This disclosure relates generally to the field of energy storage and distribution and, more specifically, to methods for predicting energy consumption demand for peak load shaving.

### BACKGROUND

Meeting peak electric demand is a fundamental challenge that utilities and grid operators, faced with rising generation, transmission, and regulatory costs, must address in efficient and economical ways. Furthermore, utilities are under increasing legislative pressure that mandates increasing integration of high-variability renewables into their generation portfolios. All the while, regulated utilities must still fulfill the terms of their monopolies granted in exchange for guarantees to meet demand, and face stiff penalties for failure.

In order to mitigate the risks associated with meeting peak demand under heavier renewables integration requirements, utilities may invest in extra generation capacity that remains idle for all but a few extreme events in the year. Such an approach incurs very high capital and operational expenses. Another long-standing approach is forecasting demand several hours to several days ahead, and hedging against unexpected spikes in demand or generation failures by purchasing call option contracts securing the right but not the obligation to buy electricity from the wholesale market at set prices following a certain waiting period. This strategy carries its own risks: prices may fluctuate significantly as the forecast horizon decreases. A utility may lose value on its contracts if prices and/or demand drop, or the utility may need to make costly additional electricity purchases if demand spikes.

With the advent of the smart grid and associated advanced monitoring systems, utilities have increased ability to influence demand and mitigate costs by imposing variable pricing and demand charges corresponding to different periods in the day that relate to different expected loads. For instance, a utility may charge a higher per-unit price at 12:00 PM on a Wednesday in July than at 3:00 AM on a Sunday in October. Furthermore, a utility may levy a demand charge that corresponds to the peak load incurred by a customer over a given period, e.g., one month. Such charges in principle incentivize customers to reduce absolute peak usage, thereby reducing the cost to the utility of excessive reserve provisioning.

To cope with demand charges and energy efficiency goals, customers are increasingly turning to sophisticated building energy management systems (EMS). EMS are cyber-physical systems comprised of software and hardware that enable real-time monitoring, control, and optimization of electricity generation, transmission, storage, and usage. Together with stationary energy storage systems, an EMS enables a building manager to reduce or defer grid electricity consumption during periods of high demand charges. As used herein, the term “peak load shaving” refers to an energy management approach wherein grid electricity consumption is reduced during periods of peak demand. Such reductions are especially beneficial in the case of demand charges or inelastic demand that can be met by stored, dispatchable energy reserves. Consequently, improvements to EMSs that improve the effectiveness of stationary energy storage systems in providing peak shaving would be beneficial.

### SUMMARY

In one embodiment, a method for peak load shaving in an energy management system (EMS) has been developed. The method includes identifying with a controller an available energy capacity of an energy storage device in the EMS, estimating with the controller a level and duration of peak power consumption for a load connected to the EMS over a predetermined time period based on a feed-forward neural network trained with a history of peak power consumption measurements by the EMS, identifying with the controller a power consumption threshold for the load connected to the EMS with reference to the level and duration of peak power consumption estimated by the controller and the available energy capacity of the energy storage device, measuring with the controller a power consumption level of the load during the predetermined time period, and activating with the controller the energy storage device to provide energy to the load from the energy storage device in response to the measured power consumption level of the load exceeding the threshold.

In another embodiment, an EMS that performs peak load shaving has been developed. The EMS includes an energy storage device connected to a load and to an external electrical power source and a controller operatively connected to the energy storage device. The controller is configured to identify an available energy capacity of an energy storage device in the EMS, estimate a level and duration of peak power consumption for a load connected to the EMS over a predetermined time period based on a feed-forward neural network trained with a history of peak power consumption measurements by the EMS, identify a power consumption threshold for the load connected to the EMS with reference to the level and duration of peak power consumption estimated by the controller and the available energy capacity of the energy storage device, measure a power consumption level of the load during the predetermined time period, and activate the energy storage device to provide energy to the load from the energy storage device in response to the measured power consumption level of the load exceeding the threshold.

A method to assist in peak load shaving with an energy storage device includes generation of adaptive estimates of the load threshold for which the energy consumed by the load exceeding the threshold is equal to the effective capacity of the storage system. An energy management system (EMS) generates threshold predictions beginning during a period when demand is low, and are updated throughout the day using the observed load samples and previous threshold estimates as additional inputs. The EMS uses the estimates to control the stationary energy storage device to discharge whenever total load exceeds the current threshold estimate, and to charge to full capacity whenever total load falls below the current estimate.

There are three main benefits for generating predictions of the load threshold when compared to other methods. First, the predictions mitigate the uncertainty in predicting daily peak load or hourly load, which is often highly variable, by instead computing what amounts to an average over several hours. The threshold is a proxy for excess energy consumed, and the threshold can be computed by the product of the average instantaneous excess load multiplied by the number of hours during which the load exceeds the threshold. Second, predicting thresholds over a comparatively short period, such as one hour or a window of a few hours, reduces the computational complexity in predicting the load, which typically involves a far larger training data set and an increased number of models (corresponding to each horizon from 1 to 24 hours ahead) that decrease in accuracy as horizon increases. Instead, a single threshold suffices to convey the information that the controller 112 requires to characterize the load for a day. Third, the controller generates individual hourly models to forecast the threshold on the basis of information up to that hour, the controller 112 adaptively adjusts the estimate of the threshold and can more accurately capture surprise events that occur during the morning ramp up to peak load.

The systems and methods described herein enable peak shaving using threshold prediction. The prediction method makes a novel application of state of the art forecasting technology to quantify the threshold such that energy consumed by load in excess of the threshold equals a desired amount. One embodiment uses artificial neural networks for developing threshold predictions for the load profile of a school. The threshold prediction method is not limited to peak shaving since threshold prediction methods can also be used to determine other energy quantities related to daily load. The embodiments described herein are not model-dependent, and can be implemented using arbitrary nonlinear regression and training methods.

### BRIEF DESCRIPTION OF THE DRAWINGS

FIG. 1 is a diagram of an energy management system (EMS).

FIG. 2 is a time diagram that depicts peak shaving in an EMS.

FIG. 3 is a flow diagram of a training process for a neural network that is used in the system of FIG. 1.

FIG. 4 is a flow diagram of an evaluation process in the EMS of FIG. 1.

FIG. 5 is a diagram of a feed-forward neural network that is used in some embodiments of the EMS of FIG. 1.

FIG. 6 is a diagram depicting peak loads and threshold levels in one embodiment of the EMS of FIG. 1.

FIG. 7 is a diagram that depicts a comparison between predicted and measured peak loads and thresholds in the EMS of FIG. 1.

### DETAILED DESCRIPTION

For the purposes of promoting an understanding of the principles of the embodiments disclosed herein, reference is now be made to the drawings and descriptions in the following written specification. No limitation to the scope of the subject matter is intended by the references. The present disclosure also includes any alterations and modifications to the illustrated embodiments and includes further applications of the principles of the disclosed embodiments as would normally occur to one skilled in the art to which this disclosure pertains.

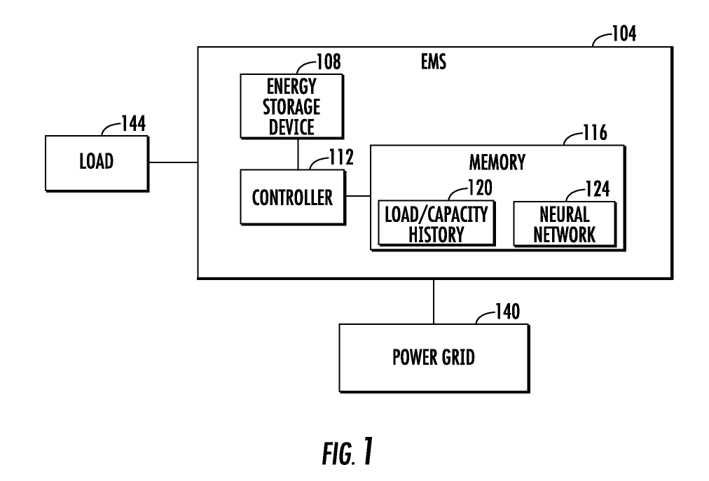

FIG. 1 depicts an illustrative embodiment of an energy management system (EMS) 104. The EMS 104 includes an energy storage device 108, controller 112, and a memory 116. The EMS 104 controls the delivery of power to a load 144 from a power grid 140 or from the energy storage device 108. The energy storage device 108 is, for example, a battery, fuel cell, or any other suitable energy storage device that can store energy that is drawn from a power grid 140 or other suitable source during an off-peak demand period and discharge to deliver energy to a load 144 during a peak power consumption period to enable the EMS 104 to perform peak load shaving. The energy storage device 108 has a predetermined maximum energy capacity (e.g. 100 kWh) and an effective energy capacity that is between zero and the maximum energy capacity that corresponds to the actual level of energy stored in the energy storage device 108 at different times during operation of the EMS 104. The controller 112 is a digital computing device or other suitable control device that is configured to predict the effective capacity of the energy storage device 108 over time and the load demands of the load 144 over time compared to peak demand periods on the power grid 140. The memory 116 stores a history of the demand of the load 144 and the effective capacity of the energy storage device 108 over time. The memory 116 also stores data corresponding to a neural network predictor 124. The controller 112 uses threshold generated by the neural network predictor 124 and capacity history data 120 to compute power commands to the energy storage device 108.

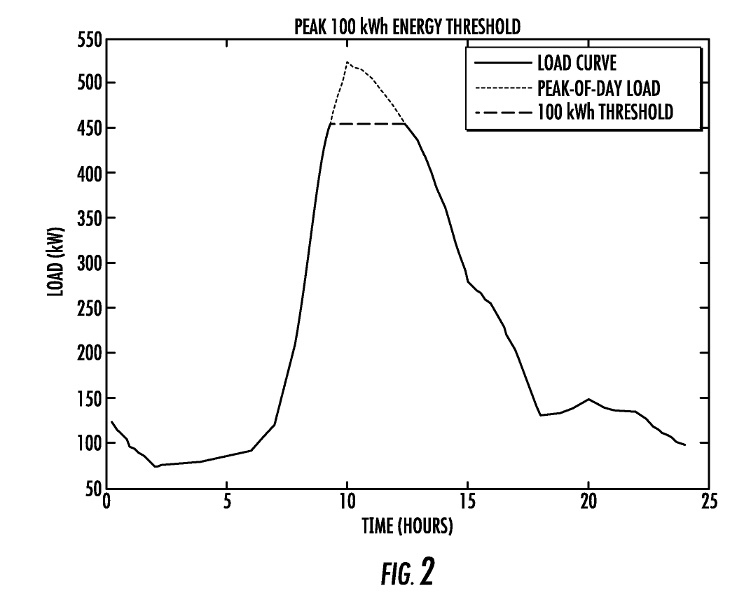

The goal of threshold prediction is to quantify the threshold such that the total energy consumed by load exceeding that threshold is equal to a specified amount (e.g., 100 kWh). FIG. 2 depicts a typical weekday load profile from a commercial customer. The threshold for which excess energy equals 100 kWh is indicated in red, while the excess demand is indicated in green. The controller 112 identifies the threshold via numerical integration of the load curve.

The threshold prediction method makes use of pattern recognition and machine learning algorithms that find relationships within observed data. Given a load profile consisting of predictor-output pairs, with predictors, such as time of day/week/year, operating schedule, temperature, and previous loads, and associated outputs, such as measured loads, the controller 112 first compute thresholds for each day. The controller 112 uses the thresholds to create a new profile containing pairs consisting of predictors and daily thresholds. Note that while the initial load profile may have been sampled hourly or sub-hourly, a threshold profile consists of daily pairs.

The controller 112 uses statistical learning algorithms to build a discriminative model that estimates a functional relationship between predictors (inputs) and thresholds (outputs) using the training set of predictor-threshold pairs. Discriminative modeling frameworks include nonlinear regression models such as artificial neural networks, support vector machines, and kernel-smoothing regression, and enable the estimation of an unseen mean conditional on an observation. The controller 112 uses the trained model to predict unseen thresholds in the test set using predictor vectors.

The controller 112 generates a different model for each hour of the normal day shift (e.g., 8 AM to 3 PM). In addition to inputs that all models share such as the previous day peak load and threshold, each model uses the most recent measured load and estimated threshold as additional inputs. Thus, the EMS 104 operates with as many threshold profiles as there are models to be trained, and each daily threshold has a distinct input vector corresponding to each particular model.

By using multiple models, the prediction method adapts each individual day's estimated threshold each hour as new data becomes available. The hourly estimated threshold is used as an input to a controller that switches between charge and discharge modes depending on whether or not the load exceeds the current threshold estimate.

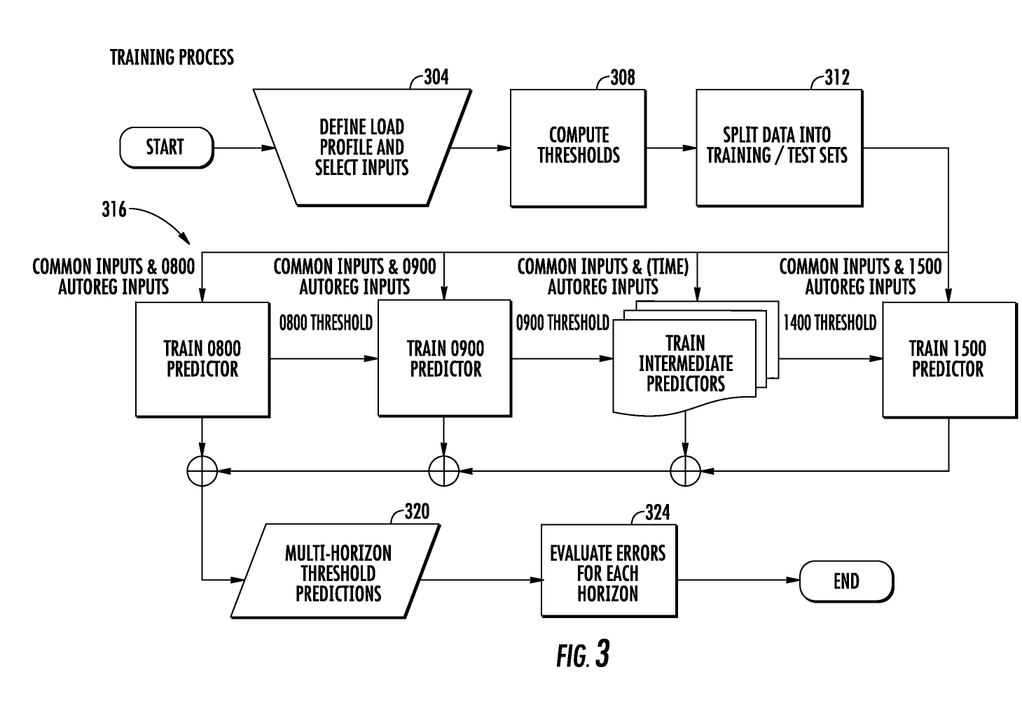

FIG. 3 depicts a training process that is used to generate a model, such as a feed-forward neural network, that predicts load and storage capacity thresholds in the EMS 104. The controller 112 executes stored program instructions to perform the training process. The process includes defining load profile and choose predictors (e.g., previous day's peak load, previous day's thresholds, most recent hour's load, previous day's peak temperature, today's forecasted peak temperature, etc.) (block 304). The process continues with computation of the thresholds via numerical integration (block 308). The controller 112 splits data into training/testing sets in order to train chosen nonlinear regression model (block 312). The controller 112 then performs predictor training over a series of time periods, such as individual hours of the day as depicted in FIG. 3 (block 316). For example, the training in the first hour (0800) predictor uses threshold data observed during the previous day as input. The controller 112 executes multiple trainings and chooses performer with smallest training set error. For training of additional predictors for subsequent time periods controller 112 uses the threshold values from the previous hour as additional input. The controller 112 executes multi-hour threshold estimates for the full data set (block 320) and reports errors for test set (block 324).

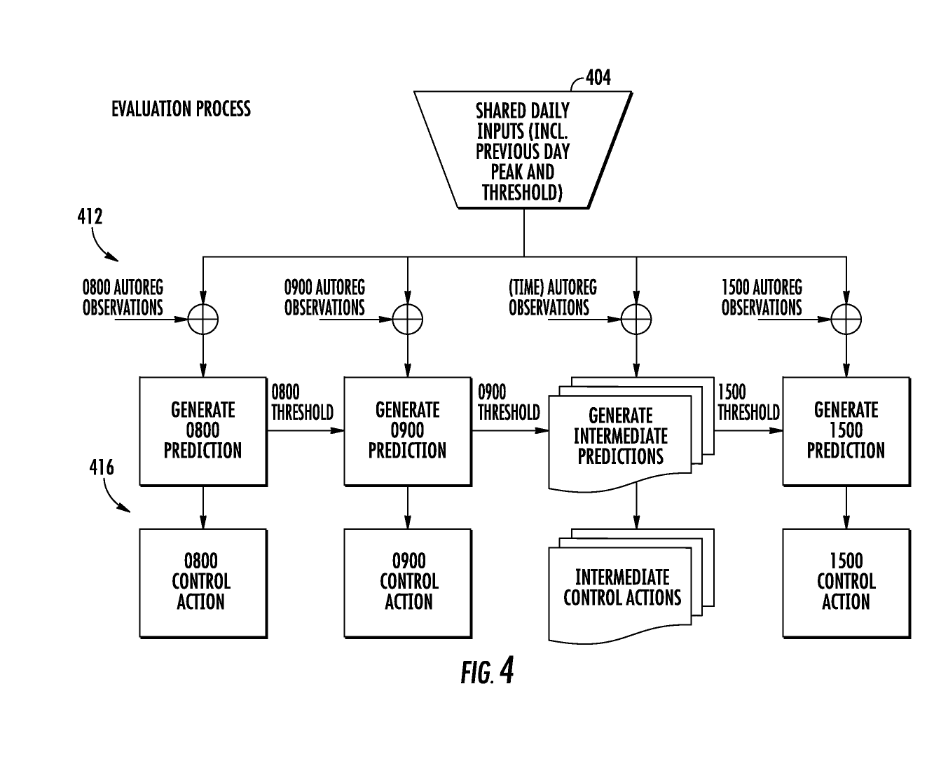

FIG. 4 depicts a control process for the EMS 104 that is using previously generated models to evaluate different threshold levels that are used to control the charging and discharging of the energy storage device 108 to perform peak power shaving. The predictor 124 executes stored program instructions to perform the evaluation process in FIG. 4. During the evaluation process, the predictor 124 chooses day to forecast and obtain required inputs (e.g., previous day's load and temperature information, chosen day's forecasted temperature, etc.) (block 404). The predictor 124 generates a series of estimates for predetermined time periods (e.g. hourly estimates) (block 412). For example, the predictor 124 generates first hour (0800) threshold estimates and generates estimates for additional hours during the day. During each hour, the predictor 124 obtains load measurements for the previous hour and generates subsequent threshold estimates. The controller 112 performs actions based on the threshold estimates to either discharge the energy storage device 108 during periods of peak load for peak load shaving or to recharge the energy storage device 108 from an external electrical power source such as an electrical utility grid during load periods that are below the peak load threshold (block 416).

In one embodiment, the EMS 104 uses a neural network model to obtain threshold predictions for the load profile of a commercial customer. The neural network is an example of one embodiment of a prediction model. Alternative configurations of the EMS 104 use different predictors and modeling frameworks. Furthermore, alternative embodiments also apply the threshold prediction algorithm to other thresholds besides the daily peak excess energy, such as for instance the threshold over which the peak 100 kWh of morning ramp up energy usage falls. Neural networks are one modeling approach in the load forecasting literature to model the highly nonlinear relationship between predictors such as temperature and seasonality and historical load. Neural networks are particularly suited to learning curves for situations that are not well suited to development of parametric models or physics-based models, and have been successfully applied to numerous regression and classification problems.

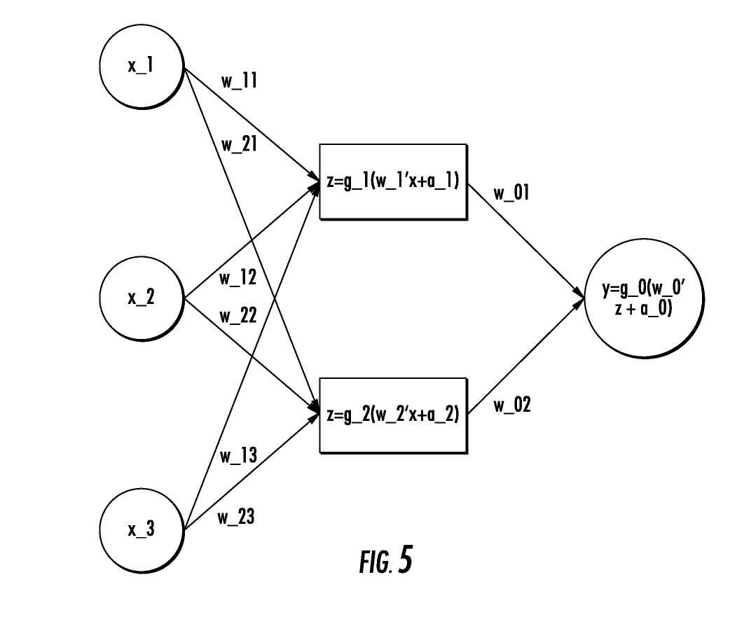

The embodiment of FIG. 5 depicts a single-layer feed-forward neural network. Such a network consists of a set of n input units, each connected to m shared hidden units, which are in turn connected to p output units. In regression-type problems, the neural network often has a single output unit. In this context, the input units represent predictors or independent explanatory variables which have been normalized to lie within the interval [−1,1], and the output unit is a dependent variable. The hidden units represent activation functions that each map a linear combination of inputs to a scalar output. Mathematically, the neural network is represented by the following model:

yₖ(x)=hₖ(Σᵢ₌₁^{m}vᵢgᵢ(Σⱼ₌₁ⁿwᵢⱼxⱼ+∝ᵢ)+∝₀)

In the neural network model, xⱼ refers to the inputs, yₖ refers to the outputs, ∝ᵢ and ∝₀ refer to bias terms, hₖ refer to output activation functions, gᵢ refers to hidden layer activation functions, vᵢ refers to weights for the hidden layer activation functions gᵢ, and wᵢⱼxⱼ.
In one configuration, the neural network is trained using a maximum likelihood framework. In an embodiment that utilizes a Gaussian distribution of errors conditional on observed input data, the maximization of likelihood is equivalent to minimizing a least squares cost function equal to the sum of the squared difference between the outputs y of the neural network and the corresponding measured thresholds, or targets, t. Because the cost function includes non-convex parameters, the optimization problem may not have a unique global optimum, and nonlinear optimization algorithms can be used to train the network.

A major potential pitfall is overfitting, in which a nonlinear regression fits the training data very well, but performs poorly when predicting new data. Neural networks are susceptible to overfitting when the number of model parameters approaches or exceeds the number of data points. The controller 112 restricts the number of parameters in the model to be no more than 10% of the number of data points. The use of independent validation sets also help to obtain models with good generalization performance, and typically encourage selection of more parsimonious models.

Before beginning training, the controller 112 reserves a random subset of the training data for validation. During training, the controller 112 monitors the cost function on both the remaining training data as well as the set held out for validation, and stops training once the validation set error no longer decreases (even if the remaining training set error continues to decrease). Optimal network size often depends on the data, and the controller 112 selects the number of hidden units by training several network sizes several times, using a different validation set each time, and choosing the best performer on the basis of mean absolute error between training and target points on independent test sets not used during the training period. The controller 112 trains the neural network in a similar manner to k-fold cross validation, in which the training data is partitioned into k subsets and the network is trained k times, each time holding out one of the subsets for validation. Network performance is evaluated on the basis of overall performance on the validation subsets for each network size. The controller 112 uses Bayesian regularized gradient descent to determine parameters v, w, and α that minimize (perhaps locally) the least squares cost function. Bayesian regularization penalizes overfitting and maintains a parsimonious model by assigning parameter weights close to zero to inputs deemed irrelevant. Several other approaches to determine relevant inputs such as F tests and sensitivity analysis are viable alternatives.

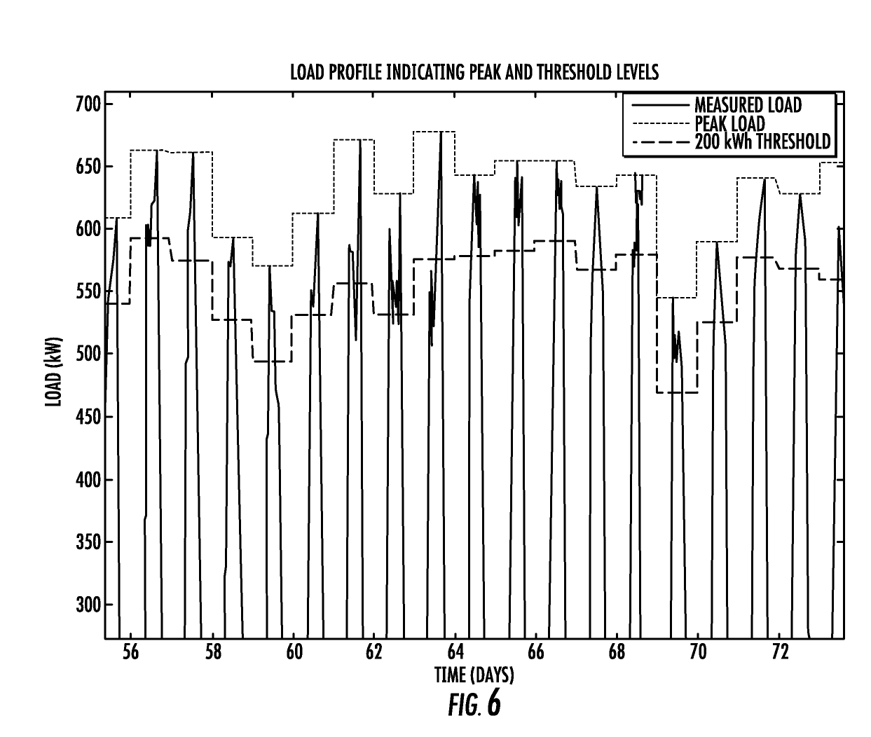

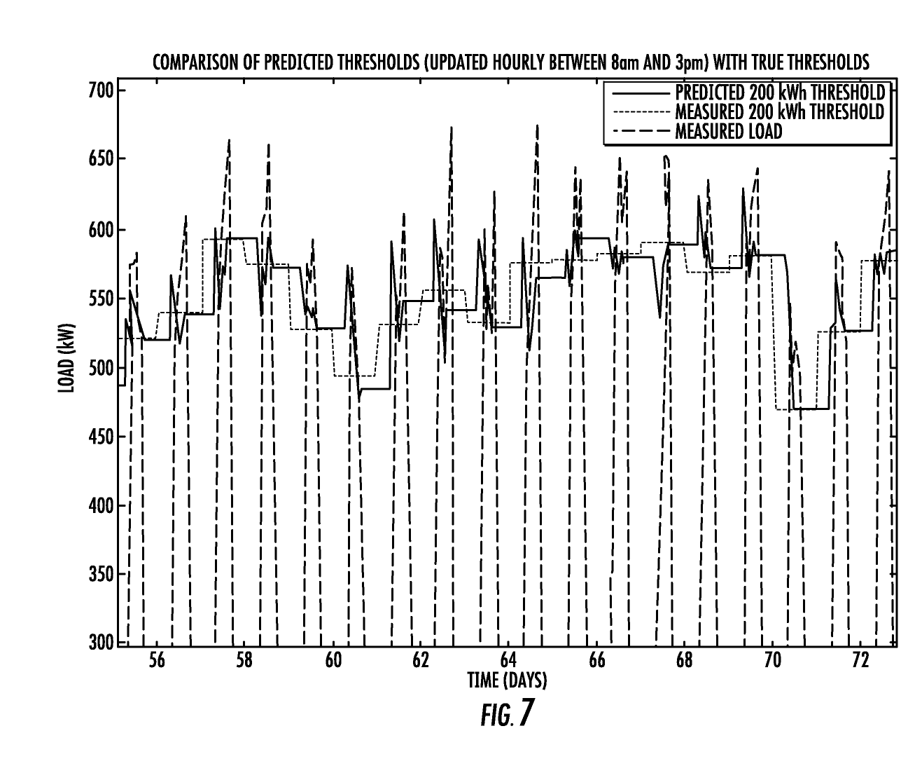

FIG. 6 depicts a measurement of peak loads and a 200 kWh threshold over a historic time period recorded in 2007. FIG. 7 depicts results of the predictions made for the 200 kHh threshold in an EMS system compared to the actual results for the same time period that is depicted in FIG. 6. In one illustrative embodiment, the neural network model is trained using one year of load data from a commercial customer. Because peak shaving over an entire month is of interest, the model omits weekend days since peak loads on the weekends are substantially below weekday peak loads. The training data set are selected by picking the weekdays corresponding to the first 20 days of each 30 day period of the year. The validation set is a randomly chosen subset from the training set consisting of 30% of the original training data.

The controller 112 uses a trapezoidal numerical integration algorithm to compute thresholds that are illustrated in FIG. 6. Owing to the limited number of data points (one predictor/threshold per day), the controller 112 uses one hidden unit to guard against overfitting. The inputs we use are today's forecasted mean temperature, the mean and peak temperatures of the previous day, the forecasted peak temperature of the present day, the threshold of the previous day threshold, the peak and minimum loads of the previous day, time of year, type of day, and most recent load measurements over the past hour.

In one embodiment, the controller 112 performs ten rounds of training for each threshold model, and picks the best performer according to minimum training set error. FIG. 7 depicts the predicted thresholds over a period of several days. The training and evaluation process adapted to an EMS for a particular load is summarized below. The process includes defining weekdays and determining a load profile; computing thresholds via numerical integration; determining threshold profile data set: today's forecasted mean temperature, the previous day's mean temperature, today's forecasted peak temperature, previous day's peak temperature, yesterday's threshold, yesterday's peak load, time of year, type of day, yesterday's minimum load, and most recent load measurements over the past hour; initializing feed-forward neural network with one hidden unit with a tangent-sigmoidal activation function and select Bayesian regularization descent; splitting data into training/testing sets; training a first hour (e.g. 0800) predictor using previous day's threshold as input; performing multiple training rounds and choosing a round with the smallest training set error; training subsequent predictors using previous hour predictor's threshold as additional input; running multiple trainings and choose performer with smallest training set error; and computing multi-hour threshold estimates for full data set and report errors on test set.

It will be appreciated that variants of the above-disclosed and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the following claims.

What is claimed:

1. A method of peak load shaving in an energy management system (EMS) comprising:
identifying with a controller an available energy capacity of an energy storage device in the EMS;
estimating with the controller a level and duration of peak power consumption for a load connected to the EMS over a predetermined time period based on a feed-forward neural network trained with a history of peak power consumption measurements by the EMS;
identifying with the controller a power consumption threshold for the load connected to the EMS with reference to the level and duration of peak power consumption estimated by the controller and the available energy capacity of the energy storage device;
measuring with the controller a power consumption level of the load during the predetermined time period; and
activating with the controller the energy storage device to provide energy to the load from the energy storage device in response to the measured power consumption level of the load exceeding the threshold.

2. The method of claim 1 further comprising:
deactivating with the controller the energy storage device in response to the measured power consumption level of the load dropping below the threshold.

3. The method of claim 1 further comprising:
connecting with the controller the energy storage device to an external electrical power source to recharge the energy storage device in response to the measured power consumption level of the load dropping below the threshold.

4. The method of claim 1 further comprising training with the controller the feed-forward neural network, the training further comprising:
measuring with the controller a first plurality of inputs corresponding to a plurality of power consumption levels of the load over a plurality of predetermined time periods;
identifying with the controller a first plurality of outputs corresponding to threshold levels for activation of the energy storage device with reference to an integration of load power consumption levels over the plurality of predetermined time periods and a predetermined capacity of the energy storage device; and
generating with the controller the feed-forward neural network including a discriminative model based on the first plurality of inputs and the first plurality of outputs for the load in the EMS.

5. The method of claim 4, the training further comprising:
measuring with the controller a second plurality of inputs corresponding to at least one of a temperature, humidity, and wind speed during the plurality of predetermined time periods; and
generating with the controller the feed-forward neural network including the discriminative model based on the second plurality of inputs.

6. The method of claim 4 wherein each time period in the plurality of predetermined time periods corresponds to one weekday in a week for a plurality of weeks.

7. The method of claim 4 wherein each time period in the plurality of predetermined time periods corresponds to one hour of day for a plurality of days.

8. The method of claim 4, the training further comprising:
generating the feed-forward neural network with a single hidden variable based on a tangent-sigmoidal activation function and select Bayesian regularization descent.

9. An energy management system (EMS) configured to perform peak load shaving, the EMS comprising:
an energy storage device connected to a load and to an external electrical power source; and
a controller operatively connected to the energy storage device, the controller being configured to:
identify an available energy capacity of an energy storage device in the EMS;
estimate a level and duration of peak power consumption for a load connected to the EMS over a predetermined time period based on a feed-forward neural network trained with a history of peak power consumption measurements by the EMS;
identify a power consumption threshold for the load connected to the EMS with reference to the level and duration of peak power consumption estimated by the controller and the available energy capacity of the energy storage device;
measure a power consumption level of the load during the predetermined time period; and
activate the energy storage device to provide energy to the load from the energy storage device in response to the measured power consumption level of the load exceeding the threshold.

10. The system of claim 9, the controller being further configured to:
deactivate the energy storage device in response to the measured power consumption level of the load dropping below the threshold.

11. The system of claim 9, the controller being further configured to:
connect the energy storage device to the external electrical power source to recharge the energy storage device in response to the measured power consumption level of the load dropping below the threshold.

12. The system of claim 9, the controller being further configured to:
measure a first plurality of inputs corresponding to a plurality of power consumption levels of the load over a plurality of predetermined time periods;
identify a first plurality of outputs corresponding to threshold levels for activation of the energy storage device with reference to an integration of load power consumption levels over the plurality of predetermined time periods and a predetermined capacity of the energy storage device; and
generate the feed-forward neural network including a discriminative model based on the first plurality of inputs and the first plurality of outputs for the load in the EMS.

13. The system of claim 12, the controller being further configured to:
measure a second plurality of inputs corresponding to at least one of a temperature, humidity, and wind speed during the plurality of predetermined time periods; and
generate the feed-forward neural network including the discriminative model based on the second plurality of inputs.

14. The system of claim 12 wherein each time period in the plurality of predetermined time periods corresponds to one weekday in a week for a plurality of weeks.

15. The system of claim 12 wherein each time period in the plurality of predetermined time periods corresponds to one hour of day for a plurality of days.
